(19) United States
(12) Patent Application Publication
(10) Pub. No.: US 2026/0011204 A1
(43) Pub. Date: Jan. 8, 2026

(54) PAPER NOTE PROCESSING METHOD, PAPER NOTE PROCESSING DEVICE, AND PAPER NOTE PROCESSING SYSTEM

(71) Applicant: GLORY LTD., Himeji-shi, Hyogo (JP)

(72) Inventors: Hiroshi Danjo, Hyogo (JP); Kazuhiro Doi, Hyogo (JP)

(21) Appl. No.: 19/330,894

(22) Filed: Sep. 17, 2025

Related U.S. Application Data
(63) Continuation of application No. PCT/JP2024/009500, filed on Mar. 12, 2024.

(30) Foreign Application Priority Data
Mar. 20, 2023 (JP) 2023-044099

(51) Int. Cl. G07D 11/235; B65H 29/62; B65H 43/04; G07D 11/125; G07D 11/16; G07D 11/60

(52) U.S. Cl. CPC G07D 11/235; B65H 29/62; B65H 43/04; G07D 11/16; B65H 2301/448; B65H 2701/1912; G07D 11/125; G07D 11/60; G07D 2211/00

(57) ABSTRACT

A sheet processing method according to the present disclosure is a method that is performed by a sheet processing device that receives a deposit of a sheet, the method including: acquiring determination information in a case where a deposit of the sheet is received from an external storage device, the determination information being information about the storage device where the sheet to be received has been stored; and providing a curl notification that the sheet has a curl in a case where the determination information satisfies a predetermined condition.

### CROSS-REFERENCE TO RELATED APPLICATIONS

This application is a Continuation Application of PCT Application No. PCT/JP2024/009500, filed on Mar. 12, 2024, which is entitled and claims the benefit of Japanese Patent Application No. 2023-044099, filed on Mar. 20, 2023, the disclosures of which including the specification, drawings and abstract are incorporated herein by reference in its entirety.

### BACKGROUND ART

Sheet processing devices capable of handling sheets such as banknotes and securities have become widespread. On the other hand, as a storage that stores sheets, there is a roll-type storage in which a sheet is stored by sandwiching it one by one by a tape or the like and winding it around a drum, which is a rotational body.

The sheet stored in a roll-type storage may have curl deformation due to wounding around a drum.

Conventionally, there has been known a sheet storage device comprising a tape-type storage unit comprising first and second linear portions for preventing curl deformation of banknotes, in which the winding of the tape is controlled such that the banknote sandwiched between two tapes is stopped at the first or second linear portions in a case where the rotation of the tape-type storage unit is stopped.

### SUMMARY

A sheet processing method according to an aspect of the present disclosure is performed by a sheet processing device, the method comprising: acquiring determination information in a case where a deposit of a sheet is received from an external storage device, the determination information being information about the storage device where the sheet to be received has been stored; and providing a curl notification that the sheet has a curl in a case where the determination information satisfies a predetermined condition.

### BRIEF DESCRIPTION OF DRAWINGS

FIG. 1 is a diagram illustrating a first example of a configuration of a sheet processing device;

FIG. 2 is a flowchart for describing a first exemplary operation of the sheet processing device;

FIG. 3 is a diagram illustrating a second example of a configuration of the sheet processing device;

FIG. 4 is a perspective view illustrating an external appearance of a part of the sheet processing device;

FIG. 5 is a flowchart for describing a second exemplary operation of the sheet processing device;

FIG. 6 is a flowchart for describing a third exemplary operation of the sheet processing device;

FIG. 7 is a flowchart for describing a fourth exemplary operation of the sheet processing device; and

FIG. 8 is a diagram illustrating an exemplary configuration of a sheet processing system.

### DESCRIPTION OF EMBODIMENTS

In the sheet storage device, a mechanism has to be additionally provided to prevent curl deformation, which complicates the device configuration and control, and increases manufacturing costs. On the other hand, in a case where a sheet processing device handles sheets with curl deformation, various defects may occur due to the curl deformation.

An object of the present disclosure is to provide a sheet processing method, a sheet processing device, and a sheet processing system that can reduce the occurrence of defects in a case where a sheet having curl deformation is received.

In the sheet processing method according to an aspect of the present disclosure, a storage state of the sheet in the storage device may be determined based on the determination information.

In the sheet processing method according to an aspect of the present disclosure, the determination information may be at least one of device recognition information for recognizing the storage device, and user recognition information for recognizing a user who deposits the sheet to the sheet processing device.

In the sheet processing method according to an aspect of the present disclosure, the predetermined condition is satisfied in a case where the storage device represented by the device recognition information may be a specific storage device.

In the sheet processing method according to an aspect of the present disclosure, the predetermined condition may be satisfied in a case where the user represented by the user recognition information is associated with a specific storage device in advance.

In the sheet processing method according to an aspect of the present disclosure, the determination information may further comprising: storage information representing whether the storage device stores the sheet in a roll-type storage; and storage time information related to a time period from storage into the storage device to collection into the sheet processing device. Whether the determination information satisfies the condition may be determined for each deposited sheet. The sheet that satisfies the condition may be transported to the first storage unit that does not feed the stored sheet, and the sheet that does not satisfy the condition may be transported to the second storage unit that can feed the stored sheet.

In the sheet processing method according to an aspect of the present disclosure, the predetermined condition is satisfied in a case where the storage information may represent that the storage is of a roll-type.

In the sheet processing method according to an aspect of the present disclosure, the predetermined condition may be satisfied in a case where the storage information represents that the storage is of a roll-type and the time period represented by the storage time information is longer than a predetermined time period.

In the sheet processing method according to an aspect of the present disclosure, in the acquiring of the determination information, an inputting operation of the determination information by a user who deposits the sheet to the sheet processing device may be received. The determination information input by the user and the curl state may be preliminarily recorded in association with each other. The determination information input by the user and the type of storage may be recorded in association with each other. In a case where the storage is a predetermined type storage, the condition may be satisfied and a curl notification may be provided. The preliminarily recorded information may be overwritten by user operation. During depositing operation, the determination information about the external storage device where the sheet to be deposited has been stored may be overwritten.

In the sheet processing method according to an aspect of the present disclosure, in a case where depositing the sheet using a transport device comprising a memory unit that records the determination information, the determination information may be received from the transport device in the acquiring of the determination information.

In the sheet processing method according to an aspect of the present disclosure, in a case where a predetermined operation of a user who deposits the sheet is received after the curl notification, the sheet deposited and received may be transported to a storage unit provided in the sheet processing device.

In the sheet processing method according to an aspect of the present disclosure, in a case where the determination information satisfies the predetermined condition, the sheet deposited and received may be transported to a first storage unit that does not feed the sheet, the first storage unit being provided in the sheet processing device; and in a case where the determination information does not satisfy the predetermined condition, the sheet deposited and received may be transported to a second storage unit that feeds the sheet, the second storage unit being provided in the sheet processing device.

In the sheet processing method according to an aspect of the present disclosure, in a case where skewing equal to or greater than a predetermined number of sheets has occurred during transport for deposit among sheets to be deposited to a storage unit that stores the sheet deposited and received, the deposit may be stopped, and a notification that skewing has occurred may be provided. In a case where skewing equal to or greater than a predetermined number of sheets has occurred during transport for dispensing among the sheets dispensed from the storage unit that stores the sheet deposited and received, the dispensing is stopped, and a notification that skewing has occurred is provided. In a case where the determination information does not satisfy the predetermined condition, it is possible to determine that there is skewing, stop the deposit or dispense, and provide a notification about skewing.

A sheet processing device according to an aspect of the present disclosure comprises: an acquiring unit that acquires determination information in a case where a deposit of a sheet is received from an external storage device, the determination information being information about the storage device where the sheet to be received has been stored; a notification unit; and a control unit that controls the notification unit to provide a curl notification that the sheet has a curl in a case where the determination information satisfies a predetermined condition.

A sheet processing system according to an aspect of the present disclosure comprises: a storage device that stores a sheet; and a sheet processing device that receives a deposit of the sheet that has been stored in the storage device, in which the sheet processing device comprises: an acquiring unit that acquires determination information in a case where a deposit of a sheet is received from an external storage device, the determination information being information about the storage device where the sheet to be received has been stored; a notification unit; and a control unit that controls the notification unit to provide a curl notification that the sheet has a curl in a case where the determination information satisfies a predetermined condition.

In the sheet processing method according to an aspect of the present disclosure, in a case where the determination information does not satisfy the predetermined condition, and skewing equal to or greater than a predetermined number of sheets has occurred during transport for dispense among the sheets dispensed from the storage unit that stores the sheet deposited and received, the storage device where the skewed sheet has been stored before deposited to the sheet processing device may be added to the specific storage device.

According to the present disclosure, the occurrence of defects can be prevented even in a case where a sheet having curl deformation is received.

Hereinafter, each embodiment of the present disclosure will be described in detail with reference to the drawings. However, detailed descriptions of well-known matters and redundant descriptions of substantially identical configurations may be omitted.

### First Embodiment

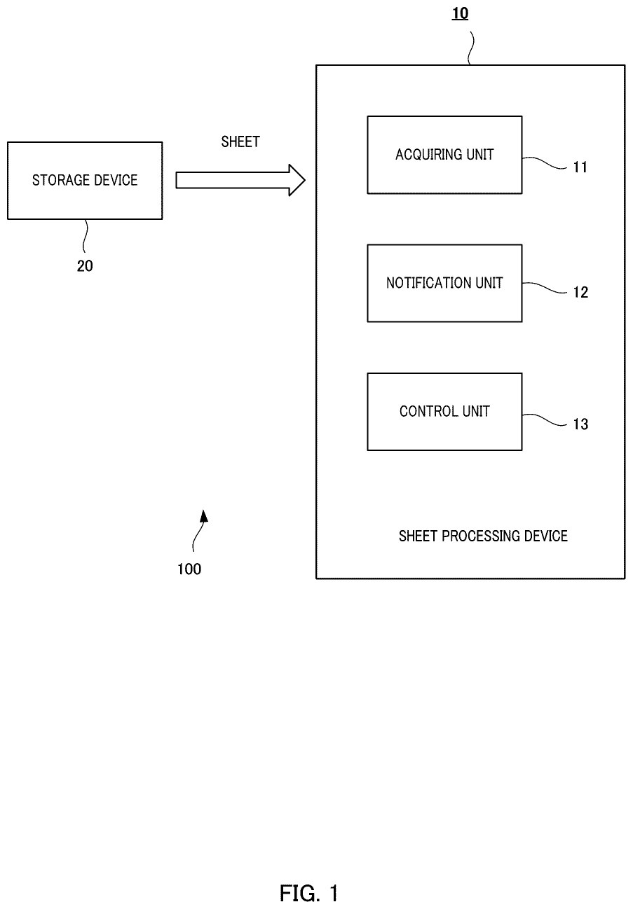

A first embodiment describes a first example of the configuration of a sheet processing device 10 according to the present disclosure. FIG. 1 is a diagram illustrating a first example of a configuration of the sheet processing device 10.

The sheet processing device 10 executes various processes on sheets such as banknotes and securities. The processes that are executable by the sheet processing device 10 comprise a process of receiving the deposit of a sheet by the sheet processing device 10.

The sheet processing device 10 comprises an acquiring unit 11, a notification unit 12, and a control unit 13.

In a case where receiving a deposit of a sheet from an external storage device 20, the acquiring unit 11 acquires determination information for determining the storage state in the storage device 20 where the sheet to be received has been stored. More specifically, the determination information is information used for the sheet processing device 10 to determine the storage state of the sheet in the storage device. Note that, in the example illustrated in FIG. 1, the system comprising the sheet processing device 10 and the storage device 20 is illustrated as a sheet storage system 100.

The notification unit 12 provides various notifications to the user of the sheet processing device 10.

In a case where the determination information satisfies a predetermined condition, the control unit 13 causes the notification unit 12 to provide a curl notification that the sheet has a curl. The control unit 13 loads and executes a corresponding program preliminarily recorded in the memory to control each unit comprising the notification unit 12, and implement the function and operation of the sheet storage system 100. The control unit 13 is a processor such as a CPU or a microprocessor, for example.

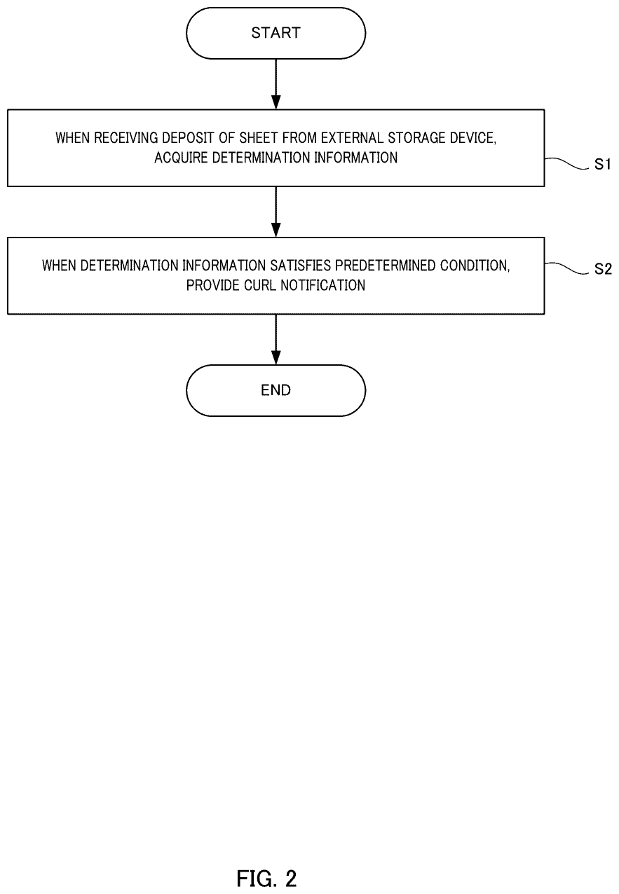

FIG. 2 is a flowchart for describing a first exemplary operation of the sheet processing device 10.

At step S1, in a case where receiving a deposit of a sheet from the external storage device 20, the sheet processing device 10 acquires determination information for determining the storage state of the sheet to be received in the storage device 20.

At step S2, in a case where the determination information satisfies the predetermined condition, the sheet processing device 10 provides a curl notification that the sheet has a curl. The curl notification may comprise animation or other display for guiding curl-reducing measure such as manually rubbing the sheet and bending the sheet to the opposite side of the curl direction for the sheet before the deposit into the sheet processing device 10.

In the sheet processing device 10 according to the first embodiment, in a case where it is determined that the sheet deposited from the external storage device 20 has curl deformation, or may have it with high possibility on the basis of the determination information, a notification that the sheet has a curl is provided to the user. This allows the user to take action such as straightening the curl using their hand, thereby preventing problems caused by the sheet having curl deformation in a case where depositing the sheet into the sheet processing device 10, for example.

### Second Embodiment

A second embodiment describes determination information acquired by the acquiring unit 11 in the first embodiment, and a predetermined condition determined on the basis of the determination information.

In the second embodiment, the determination information is at least one of device recognition information for recognizing the external storage device 20, and user recognition information for recognizing the user who performs a deposit of a sheet to the sheet processing device 10.

The device recognition information is information for recognizing the storage device 20 where the sheet to be deposited to the sheet processing device 10 has been stored. As a specific example, the device recognition information comprises information related to an ID that is previously assigned to each storage device 20, information regarding the company that manufactured the storage device 20, and information representing the type of the storage device 20.

Further, in the case where the determination information is the device recognition information, the predetermined condition is satisfied in a case where the storage device 20 represented by the device recognition information is a specific storage device 20. As a specific example, the control unit 13 determines that the predetermined condition is satisfied in a case where the ID of the storage device 20 matches a specific ID representing a preliminarily set specific storage device 20, for example. Alternatively, the control unit 13 determines that the predetermined condition is satisfied in a case where the company manufactured the storage device 20 is not a preliminarily set specific company, for example.

Alternatively, the control unit 13 determines that the predetermined condition is satisfied in a case where the type of the storage device 20 is a specific type in which stored banknotes are prone to have curl deformation, for example.

For example, in the case where the ID representing the storage device 20 that is prone to cause the curl deformation is preliminarily set as a specific ID, the control unit 13 can accurately determine that the sheet to be deposited has curl deformation or may have it with high possibility on the basis of the device recognition information. In addition, in a case where the storage device 20 is manufactured by a specific company on the basis of the device recognition information, the control unit 13 can determine that there is a possibility that the sheet to be deposited has curl deformation. In addition, in a case where a sheet is deposited from a specific type of storage device 20 in which stored banknotes are prone to have curl deformation, the control unit 13 can accurately determine that the sheet to be deposited has curl deformation or may have it with high possibility on the basis of the device recognition information.

The user recognition information is information for recognizing the user who is about to deposit a sheet to the sheet processing device 10. As a specific example, the user recognition information comprises information related to an ID that is previously assigned to each user, and information representing the user's job position or role.

In the case where the determination information is the user recognition information, the predetermined condition is satisfied in a case where the user represented by the user recognition information is preliminarily associated with the specific storage device 20.

For example, in the case where there is a plurality of storages devices 20 and the corresponding storage device 20 is preliminarily set for each user, the control unit 13 can determine whether there is a possibility that the sheet to be deposited has curl deformation on the basis of the device recognition information and the user recognition information. In the case where the storage device 20 corresponding to the user is prone to cause the curl deformation, it is possible to accurately determine that the sheet to be deposited has curl deformation or may have it with high possibility.

In the sheet processing device 10 according to the second embodiment, whether the predetermined condition is satisfied is determined on the basis of the determination information comprising at least one of the device recognition information and user recognition information. In this manner, the fact that the sheet deposited from the external storage device 20 has curl deformation, or may have it with high possibility can be accurately determined.

Note that, while the control unit 13 of the sheet processing device 10 determines whether the predetermined condition is satisfied on the basis of the determination information in the second embodiment, the present disclosure is not limited to this. For example, components other than the sheet processing device 10 may determine whether the predetermined condition is satisfied on the basis of the determination information. In this case, the sheet processing device 10 may or may not provide a curl notification on the basis of a determination result of the other components by receiving the result.

### Third Embodiment

A third embodiment describes an example employed in addition to that of the second embodiment regarding the determination information acquired by the acquiring unit 11 in the first embodiment, and the predetermined condition determined on the basis of the determination information.

In the third embodiment, the determination information comprises, in addition to at least one of the device recognition information and user recognition information, storage information representing whether the storage device 20 stores sheets in a roll-type storage, and storage time information related to the time period from storage into the storage device 20 and collection into the sheet processing device.

The storage information is information representing whether the storage provided in the storage device 20 is a roll-type storage in which a sheet is stored by sandwiching it one by one by a tape or the like and winding it around a drum, which is a rotational body.

In the case where the storage information is employed as the determination information, the predetermined condition is satisfied in a case where the storage information represents that the storage is of a roll-type.

In the case where the storage provided in the storage device 20 is of a roll-type, the banknotes stored in the storage are prone to have curl deformation. In this manner, in the case where a sheet has been deposited from the storage device 20 comprising a roll-type storage, the control unit 13 can accurately determine that the sheet to be deposited has curl deformation or may have it with high possibility.

The storage time information is information representing the time period from storage into the storage device 20 and collection into the sheet processing device. In the case where sheets are stored in a roll-type storage, the longer the storage time, the sheets are more prone to have curl deformation.

In the case where the storage time information is employed as the determination information, the predetermined condition is satisfied in a case where the storage information represents that the storage is of a roll-type, and the time represented by the storage time information is longer than a predetermined time.

According to the sheet processing device 10 according to the third embodiment, by determining whether the predetermined condition is satisfied on the basis of the determination information comprising the storage information and storage time information, the fact that the sheet deposited from the external storage device 20 has curl deformation, or may have it with high possibility can be accurately determined.

Note that, also in the third embodiment, components other than the sheet processing device 10 may determine whether the predetermined condition is satisfied on the basis of the determination information. In this case, the sheet processing device 10 may or may not provide a curl notification on the basis of a determination result of the other components by receiving the result.

In the third embodiment described above, the storage information as the determination information may further comprise information representing the position where the sheet has been stored in the roll-type storage as well as the information representing whether the storage device 20 stores sheets in a roll-type storage. In a roll-type storage, the sheet stored first is stored on the deepest side closest to the drum, and sheets are stored on the nearer side as the number of stored sheets increases. It can be said that the sheets stored on the depth side closer to the drum are more prone to have curl deformation. As such, it is possible to determine that the sheets up to the nth sheet stored on the deepest side in the roll-type storage are highly likely to have curl deformation on the basis of the information representing the position where the sheet has been stored in the roll-type storage. It is also possible to determine that the sheets that have been stored after the n+1th sheet from the deepest side in the roll-type storage are less likely to have curl deformation.

### Fourth Embodiment

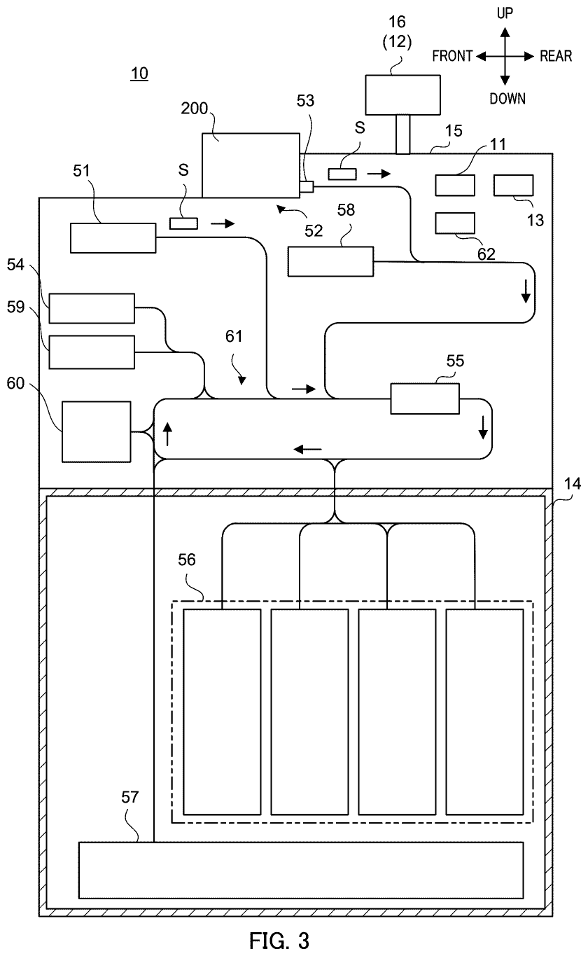

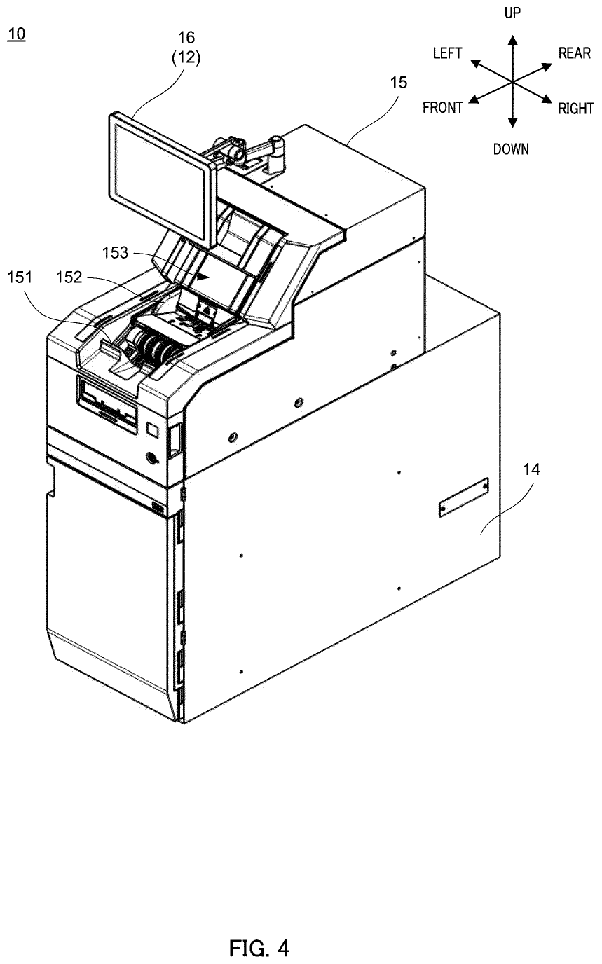

A fourth embodiment describes a second example of a configuration of the sheet processing device 10 according to the present disclosure. The second example is more specific than the first embodiment. FIG. 3 is a diagram illustrating a second example of a configuration of the sheet processing device 10. FIG. 4 is a perspective view illustrating an external appearance of a part of the sheet processing device 10. In a case where describing directions such as the front-rear direction, the left-right direction, and the up-down direction in the following, the front-rear direction, the left-right direction, and the up-down direction shall be based on those of a person facing the sheet processing device 10 as illustrated in FIG. 4.

The sheet processing device 10 comprises a lower housing 14 and an upper housing 15.

The upper housing 15 is disposed above the lower housing 14. The upper housing 15 is provided with a display operation unit 16 used for displaying and operating the sheet processing device 10. The display operation unit 16 is configured with a touch panel superimposed on a liquid crystal display or an organic EL display, for example. Note that, the upper housing 15 may comprise, in addition to the display operation unit 16, hardware operation devices such as a keyboard, a mouse, a trackball, various buttons, and various types of keys.

The display operation unit 16 is an example of the notification unit 12 illustrated in FIG. 1. Specifically, the notification unit 12 provides a notification through various displays on the display operation unit 16. Note that, the notification unit 12 is not limited to the display operation unit 16, and may be a speaker, an alarm lamp or the like not illustrated in the drawing. In this case, the notification unit 12 provides a notification using voice, light emitted from an alarm lamp or the like.

The upper housing 15 is provided with an inlet 151 and an outlet 152. In the example illustrated in FIG. 4, the inlet 151 is disposed on the rear side of the outlet 152.

In addition, the upper housing 15 is provided with a mounting port 153 making up a cassette mounting unit 52 described later. In the example illustrated in FIG. 4, the mounting port 153 is provided on the rear side of the outlet 152. The mounting port 153 is provided with an openable and closable lid, and the lid is in a closed state in the example illustrated in FIG. 4. A storage cassette 200 is mounted to the mounting port 153 with the lid opened.

The storage cassette 200 is a cassette that can be carried by the user with sheets stored therein. The storage cassette 200 is a transport device also called interface cassette or the like, for example. In a case where mounted in a specific device such as the sheet processing device 10, the storage cassette 200 can exchange sheets with that specific device, whereas in a case where separated from the specific device, sheets stored in the storage cassette 200 cannot be taken out.

The storage cassette 200 comprises at least a storage for storing sheets, and an ejection unit for discharging the stored sheets. Note that, in the present fourth embodiment, the storage of the storage cassette 200 is a roll-type storage.

Next, an internal configuration of the sheet processing device 10 is described. As illustrated in FIG. 3, the sheet processing device 10 comprises a depositing unit 51, the cassette mounting unit 52, a cassette processing unit 53, a dispensing unit 54, a recognition unit 55, a recycle unit 56, a collection unit 57, a temporary storage unit 60, a sheet transport mechanism 61, the acquiring unit 11, the control unit 13, and a memory unit 62. The depositing unit 51, the cassette mounting unit 52, the cassette processing unit

53, the dispensing unit 54, the recognition unit 55, the temporary storage unit 60, the acquiring unit 11, and the control unit 13 are provided in the upper housing 15. The recycle unit 56 and the collection unit 57 are provided in the lower housing 14. Note that, the acquiring unit 11 and the control unit 13 may be provided in the lower housing 14. The sheet transport mechanism 61 is configured to be able to transport a sheet S

between the lower housing 14 and the upper housing 15. The sheet transport mechanism 61 comprises at least a pair of rollers or an endless belt guided on at least one roller, and a motor for driving them, for example.

The depositing unit 51 accumulates the plurality of sheets S manually inserted by the user through the inlet 151, and takes in the plurality of accumulated sheets S one by one.

The cassette mounting unit 52 accepts mounting of the storage cassette 200 inserted to the mounting port 153. In a case where the storage cassette 200 is mounted to the cassette mounting unit 52, the connector of the cassette mounting unit 52 and the connector of the storage cassette 200 are connected to each other. This enables the acquiring unit 11 to access the memory provided in the storage cassette 200, and the control unit 13 to control the storage cassette 200.

The cassette processing unit 53 feeds to the sheet transport mechanism 61 the sheet S taken out from the storage cassette 200 mounted to the cassette mounting unit 52.

The dispensing unit 54 accumulates at the outlet 152 the sheet S transported from the sheet transport mechanism 61.

The recognition unit 55 generates signals indicating the denomination, authentication, and fitness of the sheets S transported by the sheet transport mechanism 61. These signals are transmitted to the control unit 13. The recognition unit 55 may generate signals for detecting the orientation and size of the sheet S being transported and the interval of the sheets S, and transmit the signals to the control unit 13.

The recycle unit 56 and the collection unit 57 receive the sheets S one by one and store the sheets S. The recycle unit 56 can feed the stored sheets S under the control of the control unit 13. On the other hand, the collection unit 57 is configured so as not to allow the feeding of the sheet S under the control of the control unit 13. In this specification, storing the sheets in such a manner that they cannot be fed by the control unit is referred to as collecting. In the present first embodiment, the recycle unit 56 and the collection unit 57 are examples of the acceptance mechanism of the present disclosure.

The recycle unit 56 comprises a plurality of storages, for example. In the present fourth embodiment, each of the plurality of storages provided in the recycle unit 56 is a stacking storage unit that stores the sheets S in a stacked manner. The plurality of storages provided in the recycle unit 56 can take and store the sheets S one by one, and feed the stored sheets one by one under the control of the control unit 13. The denomination to be stored may be preliminarily set for each of the plurality of storages.

In the example illustrated in FIG. 3, the recycle unit 56 comprises four storages, but this merely an example, and the number of storages may be smaller than three, or five or more.

In the depositing process, the temporary storage unit 60 temporarily stores the sheet S, for example.

The sheet transport mechanism 61 transports sheets among the depositing unit 51, the cassette processing unit 53, the dispensing unit 54, the recycle unit 56, the collection unit 57, and the temporary storage unit 60. The sheet transport mechanism 61 is composed of pulleys disposed at respective portions inside the sheet processing device 10, a belt provided around the pulleys and the like, for example.

The recognition unit 55 is provided in the middle of the sheet transport mechanism 61.

In the depositing operation of the sheet processing device 10, the acquiring unit 11 acquires various determination information described in the first to third embodiments.

The control unit 13 controls the entire sheet processing device 10. The control unit 13 is a processor or a microcomputer. The control unit 13 loads and executes corresponding programs preliminarily recorded in the memory such as the memory unit 62 to control each unit, and implement the function and operation of the entire sheet processing device 10.

The memory unit 62 records various information required for various operations of the sheet processing device 10, such as the determination information acquired by the acquiring unit 11. From the memory unit 62, the control unit 13 reads and uses required information in accordance with the operation of the sheet processing device 10.

In the fourth embodiment, the sheet processing device 10 is assumed to be installed in facilities where various types of sheets are handled, such as retail stores, banks, government offices, or stations. The sheet processing device 10 is, for example, installed in an office within such a facility, and a user such as a facility employee carries sheets from a storage device installed at another location in the facility to the sheet processing device for deposit. Alternatively, the user dispenses sheets from the sheet processing device and replenishes another storage device with the sheets.

A more detailed example of the usage form of the sheet processing device 10 is described below. The sheet processing device 10 is installed in an office of a retail store. Meanwhile, on the sales floor of the store, multiple register devices are installed, at which customers of the store pay for purchased goods. The register device is an example of the storage device of the present disclosure, and a plurality of banknotes for sales proceeds and change dispensing are stored in the register device.

For example, to collect the day's sales proceeds after business hours, a user such as a store manager removes banknotes from each register device and deposits the banknotes into the sheet processing device 10 located in the office. As methods for transporting the banknotes from each register device to the sheet processing device 10, there are a method in which the user manually carries them by hand or into a bag, and a method in which a transport device such as the storage cassette 200 described above (see FIG. 3) is used.

In the case where the storage cassette 200 is used, after storing banknotes into the storage cassette 200 mounted to each register device, the user detaches and transports the storage cassette 200, and sets the storage cassette 200 to the sheet processing device 10. Then, a deposit from the storage cassette 200 to the sheet processing device 10 is conducted. Note that, in a case where the storage cassette 200 is mounted to each register device, the various determination information described in the first to third embodiments may be stored from each register device to the memory provided in the storage cassette 200.

In addition, for example, before business hours begin, in order to supply banknotes for change dispensing in each register device, the user dispenses banknotes from the sheet processing device 10 and deposits them into each register device. In this case as well, the banknotes may be transported either by the user manually or using a bag, or by using the storage cassette 200, similarly to the methods described above.

In the sheet processing device 10 according to the present disclosure, either one of the transport methods, manual transport by the user using hands or a bag, or transport using the storage cassette 200, may be solely employed. In the case where only the manual transport method using hands or a bag by the user is employed, the sheet processing device 10 may not comprise the cassette mounting unit 52 and the cassette processing unit 53 exemplified in FIG. 3. On the other hand, in the case where only the transport method using the storage cassette 200 is employed, the sheet processing device 10 may not comprise the inlet 151 exemplified in FIG. 4 and the depositing unit 51 exemplified in FIG. 3.

### Depositing Operation

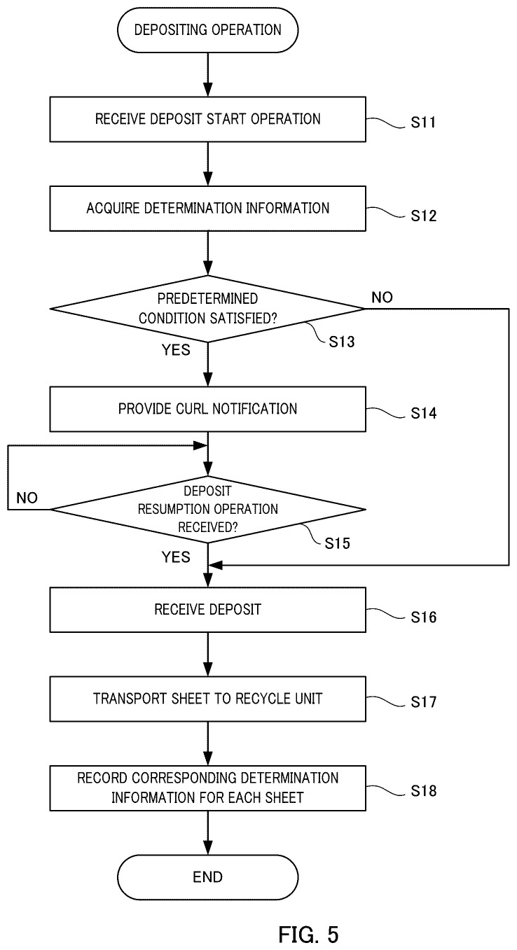

A second exemplary operation of the sheet processing device 10 according to the fourth embodiment is described below. FIG. 5 is a flowchart for describing a second exemplary operation of the sheet processing device 10. The second exemplary operation of the sheet processing device 10 is an operation of depositing a sheet to the sheet processing device 10 by the user.

At step S11, the sheet processing device 10 receives a deposit start operation by the user through the display operation unit 16. The deposit start operation is an operation of selecting the option of starting the deposit from by the user from among the options displayed on the display operation unit 16, for example.

In addition, the deposit start operation at step S11 may include an operation of inputting the various determination information described in the first to third embodiments by the user. The inputting operation of the determination information is at least one of an operation of selecting the corresponding determination information by the user from among the options displayed on the display operation unit 16, or an operation of inputting a character string representing the determination information by the user using a software keyboard displayed on the display operation unit 16 or a hardware keyboard, for example.

At step S12, the acquiring unit 11 of the sheet processing device 10 acquires determination information. The acquiring unit 11 acquires the determination information on the basis of the inputting operation of the determination information at step S11.

At step S13, the control unit 13 of the sheet processing device 10 determines whether the various predetermined conditions described in the first to third embodiments are satisfied. At step S13, in a case where it is determined that the predetermined condition is satisfied (step S13: YES), the process proceeds to step S14, whereas if not (step S13: NO), the process proceeds to step S16.

At step S14, the control unit 13 causes the display operation unit 16 serving an example of the notification unit 12 to provide a curl notification. The curl notification refers to, for example, displaying on the display operation unit 16 a message such as “!Possibly curled banknote has been deposited!” or “!Curled banknote has been deposited!”, along with graphics or designs that are likely to attract the user's attention. As another example of the curl notification, in the case where the notification unit 12 is a speaker, the notification unit 12 may provide a notification by outputting a voice message, alarm sound and the like. In addition, in the case where the notification unit 12 is an alarm lamp, the notification unit 12 may provide a notification by lighting or flashing of an alarm lamp, and the like. The notification unit 12 may perform notification using not just one, but multiple or all of the above-described examples. The curl notification may also comprise a message prompting the user to reduce curling.

Degree information representing the degree of sheet curl may be preliminarily recorded in the memory unit 62 in association with the determination information, so as to prompt the user to take measures to reduce the curl in curl notification in the case where it is determined that the degree of curl is equal to or greater than a certain degree.

With the curl notification in step S14, in a case where the user has transported the sheets using hands or a bag, the user can make efforts to eliminate the curl deformation by performing curl reduction measures on the sheets before depositing them into the sheet processing device 10, such as manually rubbing them or bending them in the direction opposite to the curl. Note that, the curl notification at the display operation unit 16 may comprise animation or other display for guiding curl-reducing measure such as manually rubbing the sheet and bending the sheet to the opposite side of the curl direction for the sheet before the deposit into the sheet processing device 10.

At step S15, the sheet processing device 10 determines whether deposit resumption operation has been received. The deposit resumption operation is an operation to stop the curl notification and resume the deposit. More specifically, the deposit resumption operation is an operation of selecting the option to resume the deposit by the user from among the options displayed on the display operation unit 16. For example, in a case where a curl notification is displayed and an “OK” button displayed on the display operation unit 16 is pressed or selected, it is possible to determine that the option to resume the deposit has been selected.

In a case where it is determined at step S15 that the deposit resumption operation has been received (step S15: YES), the process proceeds to step S16, whereas if not (step S15: NO), the process of step S15 is repeated until the deposit resumption operation is received.

At step S16, the depositing unit 51 of the sheet processing device 10 receives a deposit of a sheet through the inlet 151.

At step S17, the control unit 13 controls the sheet transport mechanism 61 to transport the deposited sheet to the recycle unit 56. In this manner the sheets (including sheets having been subjected to curl-reducing measures by the user) are stored into the recycle unit 56 where feeding under the control of the control unit 13 is possible.

Note that, in a case where the deposited sheet is transported to the recycle unit 56 at step S17 and the recognition unit 55 detects a skewed state of a sheet, the skewed sheet may be transported to the collection unit 57. The skewed banknote may be stored in the temporary storage unit 60, and transported to the collection unit 57 after the completion of depositing process. In a case where a skewed state is detected for a number equal to or greater than a predetermined number of sheets, the depositing process may be suspended.

At step S18, the control unit 13 records, for each sheet stored in the recycle unit 56, the determination information corresponding to the sheet in the memory unit 62.

More specifically, in the case where the nth sheet stored in the recycle unit 56 is deposited from a storage device B, the memory unit 62 records information indicating that the nth sheet stored in the recycle unit 56 has been deposited from the storage device B.

In a case where the predetermined condition is not satisfied at step S13, that is, in a case where it is highly possible that the sheet to be deposited does not have curl deformation, the process proceeds to step S16 without performing the curl notification at step S14 and determination of presence/absence of the deposit resumption operation at step S15.

As described above, in a case where the determination information satisfies the predetermined condition in the depositing operation of the sheet processing device 10, the notification unit 12 performs the curl notification, and the deposited sheet is transported to and stored in the collection unit 57.

In this manner, since the curl notification is performed only in a case where the determination information satisfies the predetermined condition, it is possible to prevent a situation where the curl notification is performed even in a case where the sheet to be deposited is not curled. In this manner, it is possible to reduce unnecessary time and labor for responding to unnecessary curl notification in the depositing operation.

In the case where the determination information comprises the device recognition information, the predetermined condition is satisfied in a case where the storage device is a specific storage device as described above. The specific storage device is an old-model storage device, a storage device manufactured by a specific company, or a storage device of a specific model, for example.

Note that, in a case where the determination information comprises the user recognition information, the predetermined condition is satisfied in a case where the user is a specific user as described above. For example, depending on the store, a person in charge of collection and supply of the sheet may be designated for each register device (storage device). In this case, the sheet processing device 10 sets the user in charge of the storage device that is prone to cause the curl deformation to the specific user. In this manner, the curl notification is provided to the specific user for each time, while the curl notification is not provided to the users in charge of other storage devices unless other conditions are satisfied. In this manner, the unnecessary time and labor of the user can be reduced.

### Depositing Operation Using Storage Cassette

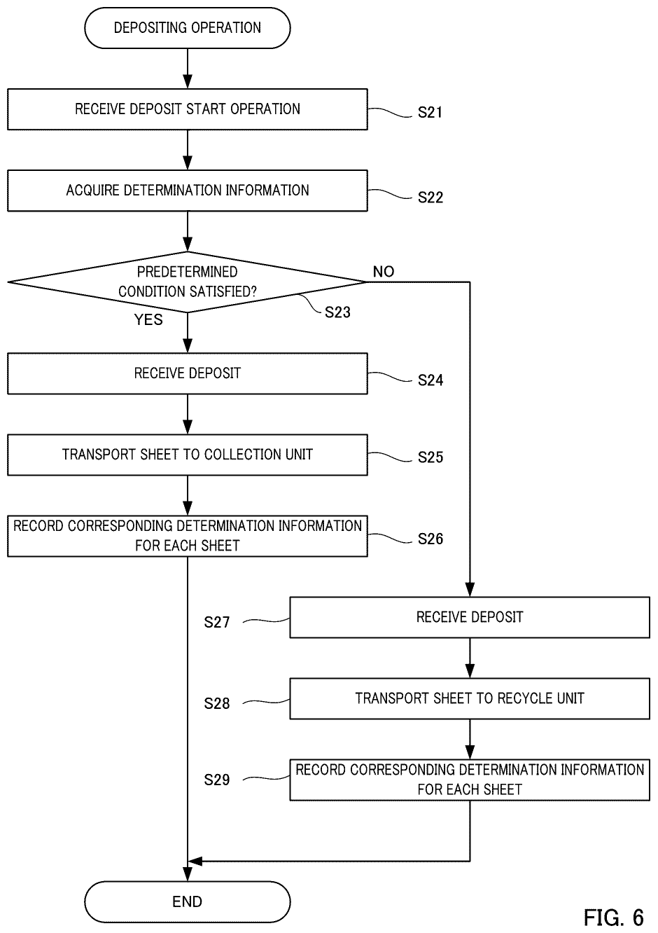

A third exemplary operation of the sheet processing device 10 according to the fourth embodiment is described below. FIG. 6 is a flowchart for describing the third exemplary operation of the sheet processing device 10. The third exemplary operation of the sheet processing device 10 is an operation in which sheets are deposited to the sheet processing device 10 using the storage cassette 200.

At step S21, the sheet processing device 10 receives the deposit start operation by the user through the display operation unit 16. The deposit start operation is operation of the user selecting the option of starting the deposit from the storage cassette 200 from among the options displayed on the display operation unit 16, for example. Note that, the sheet processing device 10 may determine the deposit start operation in a case where the storage cassette 200 is mounted to the cassette mounting unit 52.

In the case where the storage cassette 200 is used for the transportation of sheets from the storage device to the sheet processing device 10, the inputting operation of the determination information by the user may not be performed, or the inputting operation of the determination information by the user for confirmation may always be performed.

At step S22, the acquiring unit 11 of the sheet processing device 10 acquires determination information. The acquiring unit 11 may acquire the determination information on the basis of the inputting operation of the user through the display operation unit 16, or acquire the determination information from the memory provided in the storage cassette 200.

At step S23, the control unit 13 of the sheet processing device 10 determines whether the various predetermined conditions described in the first to third embodiments are satisfied. At step S13, in a case where it is determined that the predetermined condition is satisfied (step S23: YES), the process proceeds to step S24, whereas if not (step S23: NO), the process proceeds to step S27.

In a case where it is determined at step S23 that the predetermined condition is satisfied, the cassette processing unit 53 of the sheet processing device 10 receives a deposit of a sheet from the storage cassette 200 through the cassette mounting unit 52 at step S24.

At step S25, the control unit 13 causes the collection unit 57 to transport the deposited sheet by controlling the sheet transport mechanism 61. In this manner, the sheet that is determined to satisfy the predetermined condition at step S23, i.e., the sheet that is determined to highly likely have curl deformation is stored into the collection unit 57 where feeding under the control of the control unit 13 cannot be performed.

At step S26, the control unit 13 records the determination information corresponding to the sheet in the memory unit 62 for each sheet stored in the collection unit 57.

The determination information may comprise transportation time information indicating the transportation time using the storage cassette 200, in addition to the device recognition information, user recognition information, storage information, and storage time information described in the first to third embodiments. As described above, in the storage cassette 200, which employs a roll-type storage, the sheet stored for long periods of time is prone to have curl deformation. The storage cassette 200 only needs to measure the time period from the start of storage to deposit to the sheet processing device 10 and transmit it as transportation time information to the sheet processing device 10, and the sheet processing device 10 only needs to determine whether the transportation time information satisfies a predetermined condition (such as whether the transportation time is not shorter than a predetermined time period).

Further, the determination information may comprise curl direction information related to the direction of the curl of a sheet that is formed in a case where storing it into the storage provided in the storage device and the direction of the curl of a sheet that is formed in a case where storing it into the storage of the storage cassette 200. For example, in the case where the direction of the curl of a sheet that is formed in a case where storing it into the storage provided in the storage device and the direction of the curl of a sheet that is formed in a case where storing it into the storage of the storage cassette 200 are opposite to each other, the curl deformation may be reduced depending on the time during which the sheets are stored in the storage cassette 200. In this manner, with the determination information comprising the transportation time information and curl direction information, the sheet processing device 10 can perform determination with higher accuracy.

In a case where it is determined at step S23 that the predetermined condition is not satisfied, the cassette processing unit 53 of the sheet processing device 10 receives a deposit of a sheet from the storage cassette 200 through the cassette mounting unit 52 at step S27.

At step S28, the control unit 13 controls the sheet transport mechanism 61 to transport the deposited sheet to the recycle unit 56. In this manner, the sheet that is determined at step S23 to not satisfy the predetermined condition, i.e., the sheet determined to be less likely to have curl deformation is stored into the recycle unit 56.

At step S29, the control unit 13 records the determination information corresponding to the sheet in the memory unit 62 for each sheet stored in the collection unit 57 as at step S26.

In the case of the deposit from the storage cassette 200 to the sheet processing device 10 in the third exemplary operation of the sheet processing device 10 illustrated in FIG. 6, the sheet processing device 10 may determine the transport destination for each sheet. In this case, the sheet determined to be curled is transported to and stored in the collection unit 57, and the sheet determined to be less likely to be curled is stored into the recycle unit 56.

Note that, at step S27 in FIG. 6, in a case where the recognition unit 55 detects a skewed state of a sheet during the transport of the deposited sheet to the recycle unit 56, the skewed sheet may be transported to the collection unit 57. The skewed banknote may be stored in the temporary storage unit 60, and transported to the collection unit 57 after the completion of depositing process. In a case where a skewed state is detected for a number equal to or greater than a predetermined number of sheets, the depositing process may be suspended.

If a curled sheet is stored to the recycle unit 56 where feeding can be performed under the control of the control unit 13, transport defects such as skewing are likely to occur in a case where that sheet is transported from the recycle unit 56 to the dispensing unit 54 or the like in the dispensing operation. By storing a curled banknote into the collection unit 57 during the depositing operation at step S28, the transport defect in the dispensing operation can be prevented.

In the third exemplary operation of the sheet processing device 10 illustrated in FIG. 6, the curl notification may be provided as in the second exemplary operation of the sheet processing device 10 illustrated in FIG. 5. In this case, the user cannot take measures of reducing the curl deformation of the sheet with the hand, and therefore the curl notification may comprise a notification that the sheets are transported to the collection unit 57 due to the possibility of curling.

In the depositing operation described in the second exemplary operation and third exemplary operation, the display operation unit 16 may receive a compulsory transport instruction operation comprising an instruction to transport the sheet to be deposited to the recycle unit 56. In a case where the display operation unit 16 receives the compulsory transport instruction operation, the control unit 13 may perform transport to the recycle unit 56 regardless of whether the deposited sheet satisfies the predetermined condition.

In addition, in the depositing operation, in a case where the control unit 13 determines that the predetermined condition is satisfied, the display operation unit 16 may receive a determination information overwrite operation of overwriting the determination information acquired by the sheet processing device 10. For example, in the case where measures for reducing the curl deformation have been performed at a storage device A where the sheet concerned has been stored, it is possible to overwrite to indicate that the storage device A is not the specific storage device. In the case where the display operation unit 16 receives the determination information overwrite operation, the sheet processing device 10 needs only to perform overwriting such that the storage device A is not the specific storage device in the determination information acquired by the acquiring unit 11.

Further, in the depositing operation, the display operation unit 16 may receive a notification selection operation for the user to select whether to provide the curl notification.

The compulsory transport instruction operation, determination information overwrite operation, or notification selection operation may be disabled depending on the user's job title represented by the user recognition information. Specifically, in the case where the user recognition information represents that the user is a store manager, the display operation unit 16 displays options to receive the compulsory transport instruction operation, determination information overwrite operation, or notification selection operation, for example. On the other hand, in the case where the user is merely a cashier, the display of such options may be omitted.

### Dispensing Operation

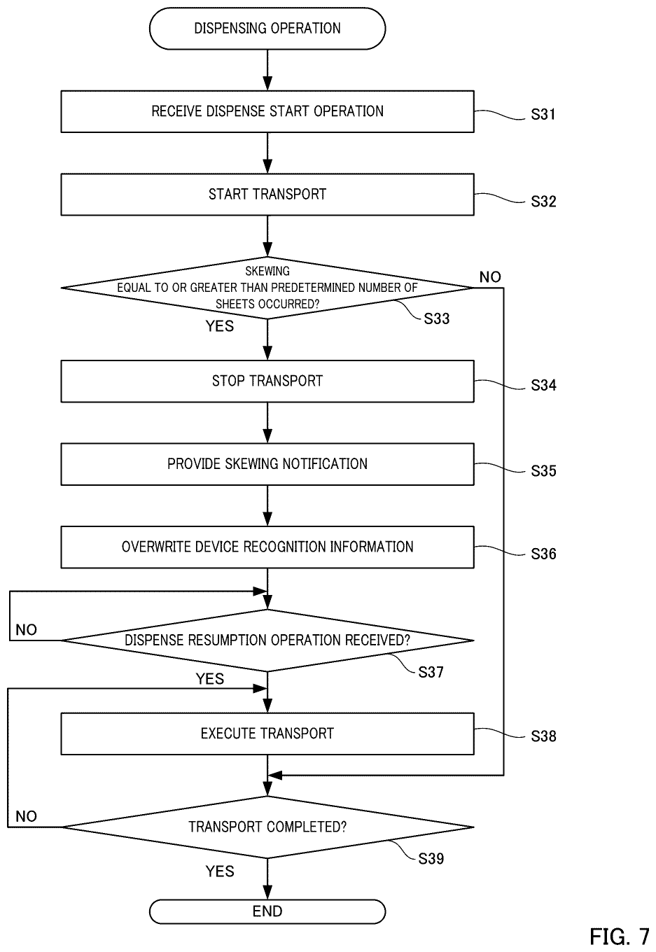

Next, the fourth exemplary operation of the sheet processing device 10 according to the fourth embodiment is described. FIG. 7 is a flowchart for describing a fourth exemplary operation of the sheet processing device 10. The fourth exemplary operation of the sheet processing device 10 is an example of a dispensing operation of sheets to the sheet processing device 10.

At step S31, the sheet processing device 10 receives a dispense start operation of the user through the display operation unit 16. The dispense start operation is an operation of selecting an option to start dispensing by the user from among the options displayed on the display operation unit 16, for example. In addition, the dispense start operation may comprise an operation of designating the denomination and the number of the sheets to be dispensed.

At step S32, the control unit 13 causes the recycle unit 56 to feed a sheet to be dispensed, and causes the sheet transport mechanism 61 to transport it.

At step S33, the control unit 13 determines whether skewing equal to or greater than a predetermined number of sheets has occurred in the sheets being transported. This determination may be performed on the basis of the location information, orientation information and the like of sheets obtained from a sensor provided in the sheet transport mechanism 61 and the like, for example. At step S33, in the case where skewing equal to or greater than a predetermined number of sheets has occurred (step S33: YES), the process proceeds to step S34, whereas if not (step S33: NO), the process proceeds to step S39.

At step S34, the control unit 13 stops transport of sheets. As a result, skewed sheets remain within the sheet transport mechanism 61.

At step S35, the control unit 13 causes the notification unit 12 to provide a skewing notification. The skewing notification refers to, for example, displaying on the display operation unit 16 a message such as “!Skewing has occurred!” along with graphics or designs that are likely to attract the user's attention. As with curl notification, in the case where the notification unit 12 is a speaker or alarm lamp, the skewing notification may be provided by means such as a voice message, alarm sound, or lamp lighting or flashing.

With this skewing notification, the user who performed the dispense process can notice that skewing has occurred during the transport. In this case, the user can access the sheet transport mechanism 61 inside the upper housing 15 or the lower housing 14 from a maintenance door of the sheet processing device 10 and the like to take measures such as removing the skewed sheet and correcting the orientation of the skewed sheet, for example.

At step S36, the control unit 13 overwrites the device recognition information corresponding to the storage device where the skewed sheet has been stored before the depositing operation, such that the device is the specific storage device.

The process of step S36 is elaborated below. As described above, in the depositing operation, information representing the storage device from which the sheets stored in the recycle unit 56 or the collection unit 57 have been deposited is recorded in the memory unit 62. Accordingly, in a case where skewing equal to or greater than a predetermined number of sheets has occurred, the control unit 13 can determine the storage device from which the skewed sheet has been deposited.

It is expected that the sheet whose skewing has been detected during dispense transportation has some defects such as curl deformation. As such, in the process of step S36, by overwriting the determination information recorded in the memory unit 62 such that the storage device B where the skewed sheet has been stored before the deposit to the sheet processing device 10 is the specific storage device that is likely to cause curl, the predetermined condition can be satisfied in a case where a sheet is deposited from the storage device B in subsequent depositing operations. In this manner, it is possible to prevent further defects such as skewing for sheets deposited from the storage device B.

Note that, in the case where the sheet processing device 10 is installed in an environment where the quality of circulating sheets is not high and causes of skewing other than curl deformation are conceivable, the process of step S36 may not be executed. Such a setting may be allowed to be performed only by a user of a specific job title, for example.

Description is returned to the dispensing operation. At step S37, the sheet processing device 10 determines whether a dispense resumption operation has been received. The dispense resumption operation is an operation of stopping the curl notification and resuming the dispensing. More specifically, the dispense resumption operation is an operation of selecting an option to resume the dispensing from among the options displayed on the display operation unit 16 by the user. The user needs only to perform the dispense resumption operation after taking measures of correcting the skew.

In a case where it is determined that the dispense resumption operation has been received at step S37 (step S37: YES), the process proceeds to step S38, whereas if not (step

S37: NO), the process of step S37 is repeated until the dispense resumption operation is received.

At step S38, the sheet processing device 10 transports sheets to be subjected to the dispensing operation.

At step S39, the sheet processing device 10 determines whether all sheets to be subjected to the dispensing operation have been transported to the dispensing unit 54. In a case where it is determined that transport of all sheets has been completed (step S39: YES), the dispensing operation is terminated, whereas if not (step S39: NO), the process is returned to step S38. In this manner, transport is performed until transport of all sheets has been completed.

As described above, in a case where skewing equal to or greater than a predetermined number of sheets has occurred in the dispensing operation of the sheet processing device 10, the skewing notification is provided, and the determination information recorded in the memory unit 62 is overwritten to set the storage device where the skewed sheet has been stored to the specific storage device.

In this manner, further defects due to skewing can be prevented, and the sheet processing device 10 can determine in subsequent depositing processes that the predetermined condition is satisfied in a case where a sheet is deposited from the storage device where the skewed sheet has been stored. By repeating the dispensing operation and depositing operation described above, the determination information recorded in the memory unit 62 can be updated at any time and the accuracy of determination whether the predetermined condition is satisfied on the basis of the determination information can be improved.

### Fifth Embodiment

A fifth embodiment describes the sheet storage system 100 comprising the sheet processing device 10 described in the first to fourth embodiments.

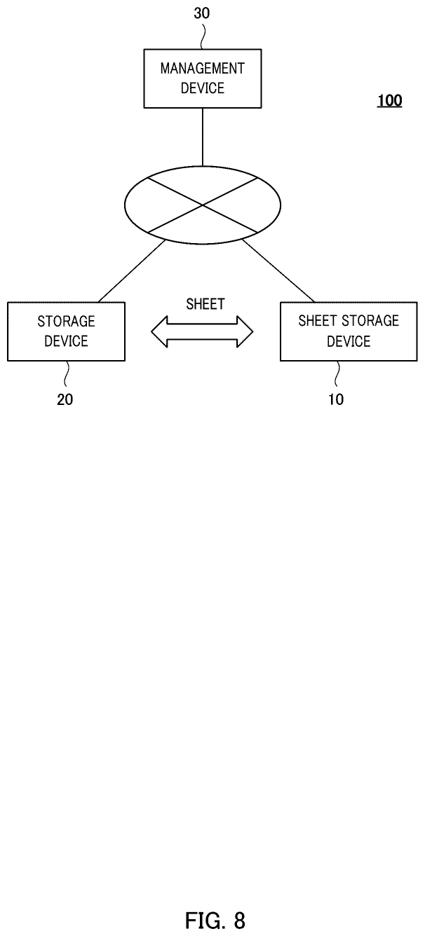

FIG. 8 is a diagram illustrating an example of a configuration of the sheet storage system 100. As illustrated in FIG. 8, the sheet storage system 100 comprises the sheet processing device 10, the storage device 20, and a management device 30. In the example illustrated in FIG. 8, the sheet processing device 10, the storage device 20, and the management device 30 are connected so as to be capable of communicating with each other via the Internet or an in-facility local area network (LAN).

The storage device 20 stores sheets. As described in the above-described first to fourth embodiments, sheets collected by the user from the storage device 20 are deposited to the sheet processing device 10 in the depositing operation. In addition, the sheets dispensed from the sheet processing device 10 in the dispensing operation is supplied to the storage device 20.

The management device 30 is communicatively connected to the sheet processing device 10 and the storage device 20, and manages the operations of the sheet processing device 10 and the storage device 20. In the above-described first to fourth embodiments, the control unit 13 of the sheet processing device 10 corresponding to the entire operation of the sheet processing device 10, but in the present fifth embodiment, the management device 30, instead of the control unit 13, may control the entire operation of the sheet processing device 10. In this case, the determination whether the determination information satisfies the predetermined condition may be performed by the management device 30, and it suffices that the determination result is transmitted from the management device 30 to the sheet processing device 10, and, various operations at the sheet processing device 10 are executed.

In addition, in the fifth embodiment, the storage device 20 may automatically transmit the determination information to the management device 30 in a case where the user collects sheets. In this case, the sheet processing device 10 may not comprise the acquiring unit 11 that acquires the determination information. The determination information acquired by the sheet processing device 10 during the depositing operation needs only to be transmitted to the management device 30, and managed by the management device 30. In this case, the determination whether the determination information satisfies the predetermined condition in the depositing operation of the sheet processing device 10 may be performed by the management device 30, or by the sheet processing device 10 that has received the determination information from the management device 30.

Note that, the fifth embodiment is merely an example of the present disclosure, and the sheet processing system according to the present disclosure may not comprise the management device. In this case, as described in the first to fourth embodiments, the sheet processing device 10 itself needs only to perform various determinations.

The configuration described in the fifth embodiment in which the management device 30 generally manages the operations of the sheet processing device 10 and the storage device 20 is suitable for a case where the sheet processing device 10 and the storage device 20 are expected in advance to be operated in conjunction with each other such as a case where the sheet processing device 10 and the storage device 20 are manufactured by the same company, for example. For example, in a case where it is not expected that the storage device 20 can generate the determination information such as in a case where the sheet processing device 10 and the storage device 20 are manufactured by different companies, the determination information needs only to be input to the sheet processing device 10 by the user operation as described in the above-described first to fourth embodiments.

### Sixth Embodiment

A sixth embodiment describes a case where sheets are moved using the storage cassette 200 among a plurality of the storage devices 20.

In some situation, the receivable denomination may be preliminarily set in the storage device 20. For example, it is assumed that a storage device 20_1 is set to receive only 10000 yen banknotes, while a storage device 20_2 is set to receive 5000 yen banknotes and 10000 yen banknotes.

It is assumed that in the storage device 20_1, the number of the stored 10000 yen banknotes has decreased, and replenishment becomes necessary. In a case where replenishment from the sheet processing device 10 is impossible, it is conceivable to supply 10000 yen banknotes from the storage device 20_2.

The storage cassette 200 can be mounted to the storage device 20_2, and the banknotes stored in the storage device 20_2 can be transferred to the storage cassette 200. It should be noted that, the storage device 20_2 cannot transfer banknotes to the storage cassette 200 by denomination, and 5000 yen banknotes and 10000 yen banknotes, which are receivable at the storage device 20_2, are randomly stored in the storage cassette 200.

In a case where 10000 yen banknotes are supplied from the storage device 20_2 to the storage device 20_1 using the storage cassette 200 described above, the following method may be employed, for example. Specifically, it is a method in which the storage device 20_1 receives 10000 yen banknotes until a 5000 yen banknote is fed from among the plurality of banknotes stored in the storage cassette 200. This method is referred to as first method in the following description.

As described above, the storage cassette 200 comprises a roll-type storage. As such, in a case where banknotes are fed from the storage cassette 200, the banknotes are sequentially fed from the side closer to the outer periphery of the drum.

It is assumed that the banknotes are fed from the storage cassette 200 in the order of 10000 yen, 10000 yen, 10000 yen, 5000 yen, and 10000 yen, for example. In this case, the storage device 20_1 can receive the first to third 10000 yen banknotes. The fourth banknote is a 5000 yen banknote, which cannot be received by the storage device 20_1, and therefore the supply of banknotes to the storage device 20_1 through the storage cassette 200 is interrupted at that point.

As described above, 5000 yen banknotes and 10000 yen banknotes are randomly stored in the storage cassette 200, and therefore in the first method, if the banknote fed first from the storage cassette 200 is a 5000 yen banknote, the storage device 20_1 cannot receive the banknote, for example.

In order to solve this problem, it suffices that the storage device 20 comprises a temporally storage unit for temporarily storing banknotes of denominations that cannot be received. In the following, a second method in which the storage device 20_1 is replenished using the temporary storing unit is described.

In the second method, it suffices that in a case where the banknote fed from the storage cassette 200 is a 5000 yen banknote, the banknote is temporarily stored in the temporary storing unit, whereas in a case where the fed banknote is a 10000 yen banknote, the replenishment is accepted. In a case where the storage cassette 200 is emptied, the storage device 20_1 returns the 5000 yen banknote temporarily stored in the temporary storing unit to the storage cassette 200. Thereafter, it suffices that the storage cassette 200 is returned to the storage device 20_2 to return the 5000 yen banknote stored in the storage cassette 200 to the storage device 20_2.

What is claimed is:

1. A sheet processing method that is performed by a sheet processing device, the method comprising:
acquiring determination information in a case where a deposit of a sheet is received from an external storage device, the determination information being information about the storage device where the sheet to be received has been stored; and
providing a curl notification that the sheet has a curl in a case where the determination information satisfies a predetermined condition.

2. The sheet processing method according to claim 1, wherein a storage state of the sheet in the storage device is determined on the basis of the determination information.

3. The sheet processing method according to claim 1, wherein the determination information is at least one of device recognition information for recognizing the storage device, and user recognition information for recognizing a user who deposits the sheet to the sheet processing device.

4. The sheet processing method according to claim 3, wherein the predetermined condition is satisfied in a case where the storage device represented by the device recognition information is a specific storage device.

5. The sheet processing method according to claim 3, wherein the predetermined condition is satisfied in a case where the user represented by the user recognition information is associated with a specific storage device in advance.

6. The sheet processing method according to claim 3, wherein the determination information further comprising:
storage information representing whether the storage device stores the sheet in a roll-type storage; and
storage time information related to a time period from storage into the storage device to collection into the sheet processing device.

7. The sheet processing method according to claim 6, wherein the predetermined condition is satisfied in a case where the storage information represents that the storage is of a roll-type.

8. The sheet processing method according to claim 6, wherein the predetermined condition is satisfied in a case where the storage information represents that the storage is of a roll-type and the time period represented by the storage time information is longer than a predetermined time period.

9. The sheet processing method according to claim 1, wherein in the acquiring of the determination information, an inputting operation of the determination information by a user who deposits the sheet to the sheet processing device is received.

10. The sheet processing method according to claim 1, wherein in a case where depositing the sheet using a transport device comprising a memory unit that records the determination information, the determination information is received from the transport device in the acquiring of the determination information.

11. The sheet processing method according to claim 1, wherein in a case where a predetermined operation of a user who deposits the sheet is received after the curl notification, the sheet deposited and received is transported to a storage unit provided in the sheet processing device.

12. The sheet processing method according to claim 1,
wherein in a case where the determination information satisfies the predetermined condition, the sheet deposited and received is transported to a first storage unit that does not feed the sheet, the first storage unit being provided in the sheet processing device; and
wherein in a case where the determination information does not satisfy the predetermined condition, the sheet deposited and received is transported to a second storage unit that feeds the sheet, the second storage unit being provided in the sheet processing device.

13. The sheet processing method according to claim 1, wherein in a case where skewing equal to or greater than a predetermined number of sheets has occurred during transport for deposit among sheets to be deposited to a storage unit that stores the sheet deposited and received, the deposit is stopped, and a notification that skewing has occurred is provided.

14. A sheet processing device comprising:
an acquiring unit that acquires determination information in a case where a deposit of a sheet is received from an external storage device, the determination information being information about the storage device where the sheet to be received has been stored;
a notification unit; and
a control unit that controls the notification unit to provide a curl notification that the sheet has a curl in a case where the determination information satisfies a predetermined condition.

15. A sheet processing system comprising:
a storage device that stores a sheet; and
a sheet processing device that receives a deposit of the sheet that has been stored in the storage device,
wherein the sheet processing device comprises:
an acquiring unit that acquires determination information in a case where a deposit of a sheet is received from an external storage device, the determination information being information about the storage device where the sheet to be received has been stored;
a notification unit; and
a control unit that controls the notification unit to provide a curl notification that the sheet has a curl in a case where the determination information satisfies a predetermined condition.
